(19) United States
(12) Patent Application Publication
(10) Pub. No.: US 2020/0296886 A1
(43) Pub. Date: Sep. 24, 2020

(54) CLEANING DEVICE FOR CLEANING CROPS AS WELL AS HARVESTING MACHINE

(71) Applicant: Arnold Jäger Holding GmbH, Hanover (DE)

(72) Inventors: Sebastian JÄGER, Hanover (DE); Johan E. ADRICHEM, Uitgeest (NL); Klaas-Jan DOB, Westeremden (NL); Harm-Jan VAN WOLDE, Huizinge (NL)

(21) Appl. No.: 16/359,634

(22) Filed: Mar. 20, 2019

(51) Int. Cl. A01D 33/08; A23N 12/00; A01D 17/02; B07B 1/14

(52) U.S. Cl. CPC A01D 33/08; B07B 1/14; A01D 17/02; A23N 12/005

(57) ABSTRACT

The invention relates to a cleaning device (2) for cleaning crops comprising a roller bed (4) comprising several rollers (3) rotatable about a rotational axis (3a), whereby gaps (10) are or can be provided between said rollers (3) in such a manner that impurities present together with the crop on an upper side (4a) of the roller bed (4) can be discharged through the gaps (10) while, at the same time, the crop can be kept on the upper side (4a), whereby the rollers (3) of the roller bed (4) can be driven in such a way that the impurities can be discharged through the gaps (10).

According to the invention, tappets (6) movable in the direction of conveyance (F) are arranged above the upper side (4a) of the roller bed (4) in such a way that crop present on the upper side (4a) of the roller bed (4) can be carried along by these tappets (6) in the direction of conveyance (F), whereby, to that end, said tappets (6) extend between at least two driver means (8; 12), whereby at least the tappets (6) arranged above said upper side (4a) of said roller bed can be moved by the at least two driver means (8; 12) in the direction of conveyance (F).

The invention relates to a cleaning device for cleaning crops according to the preamble of claim 1 as well as a harvesting machine.

In known harvesting machine for harvesting e.g. potatoes or sugar cane the crop is forwarded via conveyor belts of any type via a funnel or a feeder belt to a cleaning device in which the crop is freed mostly from larger impurities, for example, soil, stones, leaves, plant residue etc.. To that end, normally, the cleaning device comprises a roller bed to which the crop to be cleaned is fed via the funnel or the feeder belt.

To that end, the roller bed consists of several drivable rollers the rotational axes of which run in parallel to each other. Usually, a gap is provided between the rollers which is chosen in such a way that impurities that have fallen off the fed-in crop or material fed-in together with the crop via the funnel or the feeder belt and but not required can be discharged through the gaps. The fed-on crop itself is not discharged through the gaps, but usually stays on the surface of the roller bed. The surfaces of the rollers may even be in contact with each other in their default state. In this case the discharge of impurities or the material not required respectively is made possible by means of an elastic surface of the rollers. The impurities to be discharged that end up in the funnel-shaped area between the rollers deform the surfaces in this area in such a way that a gap is created through which the impurities can be discharged between the rollers.

Rotating the rollers initially leads to the crop moving on the roller bed thereby making the impurities fall off to be subsequently discharged via the gaps. To that end, adjacent rollers of the roller bed are rotated, in a known manner, in different directions of rotation about their rotational axes. This leads to the impurities ending up in the gap or, respectively, the funnel-shaped area between the rollers and being pushed through the gap. This can be optimized by means of giving the surface of the rollers a profile or structure respectively, and said structuring may also serve to shake the crop on the roller bed. This helps coarse impurities to clear free from the crop.

Furthermore, known cleaning devices are designed in such a way that the crop, when being cleaned, can be forwarded along a conveyor means on the roller bed to the next component in the chain of conveyance, e.g. a conveyor belt. For this purpose, the cleaning device may be designed to be sloping downwards in the direction of conveyance and/or the surface structure of the rollers may facilitate transport of the crop. To that end, for example, a coiled structure may be provided as the structure serving, depending on the direction of rotation of the roller, to transport the crop in the direction of conveyance and, at the same time, also to clean the crop as indicated above.

Thus, the roller bed primarily causes the crop to be cleaned but, at the same time, forwards it through the harvesting machine to the next following component in the chain of conveyance.

A disadvantage of such cleaning devices is that the rollers of the roller bed are less suited for elongated crop, for example, sugar cane. This results from the fact that the elongated crop may get jammed in the gaps and/or in the funnel-shaped areas between the rollers and transport along the direction of conveyance only via the rotation of the structured rollers cannot happen in an optimum manner because the jammed elongated crop neither rolls automatically in the direction of conveyance nor can be conveyed via the coiled structured surface.

Therefore, it is the object of the invention to provide a cleaning device for cleaning and conveying crops as well as a harvesting machine by means of which a secure transport as well as good cleaning of the crop can be achieved with little maintenance.

This task is solved by a cleaning device according to claim 1 as well as a harvesting machine according to the further independent claim. Preferred further developments are specified in the sub-claims.

Thus, according to the invention, a cleaning device for cleaning and conveying crop is provided, comprising a roller bed comprising several rollers rotatable about a rotational axis, whereby gaps are provided or can be provided between the rollers in such a way that impurities located on an upper side of said roller bed together with the crop can be discharged through said gaps while, at the same time, keeping said crop on said upper side, whereby said rollers of said roller bed can be driven in such a way that said impurities can be discharged through said gaps.

In order to achieve optimum cleaning and optimum transport using this cleaning device, the invention provides for tappets (flights, pusher dogs) movable in the direction of conveyance to be arranged at least above said upper side of said roller bed in such a way that crop located on said upper side of said roller bed can be carried along by said tappets in the direction of conveyance, whereby, to that end, the tappets extend between at least two driver means, whereby at least the tappets arranged above said upper side of said roller bed can be moved by said at least two driver means at a tapper velocity in the direction of conveyance.

The solution according to the invention allows for a secure transport of the crops to be cleaned on the roller bed in the direction of conveyance so that the cleaned crop can be fed, in a controlled manner, to the next following element in the chain of conveyance, for example, a conveyor belt. Thus, advantageously, the transport of the crops, which normally can by attained by rotation of the rollers of the roller bed, can by attained primarily by means of the movement of the tappets which force the crop in the direction of conveyance.

This leads to an overall increase of the conveyance output. Moreover, this can prevent crops from congesting and/or jamming between the rollers above the gaps provided or providable in funnel-shaped areas and/or even becoming “sucked” into the gaps. This may be the case, in particular, with elongated crop, for example, sugar cane, or even smaller crop, such as small potatoes.

Hereby, the roller bed itself can be designed to be sloping downwards or upwards in the direction of conveyance but also horizontally aligned. Primarily in the event of a roller bed sloping upwards in the direction of conveyance the tappets can effect a pushing or forcing action on the crop in the upwards direction so that upwards transport of the crops to be cleaned can be markedly improved.

Thus, the tappets help to achieve a constant flow of material on the roller bed. Also, the flow of material can be adjusted by the driver means more precisely than via the rotation of the rollers of the roller bed so that the discharge velocity or, respectively, the conveyance speed on the roller bed can be better adapted to the feed-in velocity of new crop. This improves the overall harvesting process.

Moreover, an angular velocity or, respectively, a roller velocity, at which the rollers are rotated about their rotational axes, can be selected independently from a tappet velocity at which the tappets are moved. Thus, the cleaning effect depending upon the roller velocity can be de-coupled from the transport to a large extent. Consequently, the driving of the rollers or, respectively, even the design of the roller bed as such can be adapted more efficiently to the cleaning of the crop or, respectively, the discharging of impurities. Then, the transport is primarily determined only via the tappets and their tappet velocity. The rollers may be provided as merely assisting the transport, whereby, in that case, the rollers of the roller bed can be designed and driven in such a manner that the fed-in crop is conveyed in an assisting way on the upper side of the roller bed in the direction of conveyance.

In the context of the invention, impurities shall be understood as meaning, for example, stones or soil that may be present on the respective crops and are therefore carried along into the harvesting machine. These impurities may fall off the crop by virtue of a rotation of the rollers and be discharged via the gaps. Further, in the harvesting process even plant residue (clumps, weed, stems) or leaves may end up in the harvesting machine together with the crops. Since these are considered waste and are not required, it is desired and possible to discharge also these brought-along impurities via the cleaning device.

Hereby, the afore-mentioned impurities can be discharged via the gaps between the rollers, whereby these are pulled or “sucked” in by virtue of the rotation of the rollers. The gaps must be dimensioned accordingly, such that the impurities are sucked in and can be discharged downwards while, at the same time, normally, the crop remains on the upper side of the roller bed. Hereby, the gaps can be dynamically adjustable in order to purposefully adapt the cleaning process e.g. to the harvested crop or the impurities carried along. Moreover, it may be provided that normally no gap is present between the rollers, i.e. the rollers are in contact with each other. In that case, in order to still allow the impurities to be discharged, the gaps may be formed subsequently, and this can be attained, for example, by means of an elastic, e.g. rubberized, surface of the rollers. The impurities to be discharged, which end up in the funnel-shaped area between the rollers, deform the elastic surfaces in this area in such a way that a gap is formed at least partially through which the impurities can be discharged between the rollers.

Preferably, it is further provided, that the at least two driver means are each endless driver means, preferably belts or bands, whereby each endless belt runs across at least one drive pulley and at least one deflection pulley and can be driven via the respective associated drive pulley so that the tappets extending between the at least two endless belts and being affixed to the endless belt can be moved in a continuously rotating manner, said tappets being preferably flat and band-shaped. Consequentially, an endless driver means is provided which has good running characteristics and allows for a continuously rotating movement of the tappets at tappet velocity, using few and simple means, so that no further drive means or similar are required. This minimizes expenditure and the number of components. In order to achieve consistent running properties of the tappets the drive discs associated with the respective belt must be driven in a coordinated manner so that the endless belts are also driven approximately at the same speed or synchronized respectively.

Hereby, the endless belt can be designed as a cam belt or flat belt and the discs correspondingly as toothed belt discs or flat belt discs. Thus, the transmission of movement can happen by way of positive locking or frictional connection, as is the case also in inclined conveyors in agricultural machines. The document EP 3 158 851 A1 shows, by way of example, a cam belt for such an inclined conveyor. Instead of the endless belts or bands, endless chains may be provided as endless driver means circulating on suitable drive pinions and deflector pulleys with the tappets being arranged between them.

Based on the similar design of the endless driver means in a conveyor device, e.g. in a conveyor belt, and in the present invention, it may be provided, according to a preferred embodiment, that the endless driver means of the cleaning device are integrated with endless driver means of a conveyor belt or an inclined conveyor in the harvesting machine. Hereby the conveyor belt is an adjacent element in the chain of conveyance and forwards the crop cleaned by the cleaning device to the next following element in the chain of conveyance and/or guides the uncleaned crop onto the cleaning device according to the invention. Hereby, e.g. endless belts or chains can be extended as driver means of the conveyor belt to the cleaning device and vice versa in a simple manner. Either the drive discs or drive pinions of the cleaning device and/or of the conveyor belt can be used for driving the endless driver means.

Thus, advantageously, the tappets can be utilized both for transporting the crops on the conveyor belt and for Transport transporting the crops on the cleaning device. This ensures a consistent flow of material not only within the cleaning device but also beyond the same. Hereby, there is virtually no transition between the two elements in the chain of conveyance so that the flow of material remains synchronous over all thus avoiding accumulation of material. Moreover, the conveying velocities of the two elements in the chain of conveyance do not have to be adapted to each other because the run is synchronized already.

Preferably, it is further provided to have the driver means arranged relative to the roller bed in such a way that, when the driver means are powered, the tappets affixed to the driver means are moved alternatingly above the upper side and in the turned-around state partially below a bottom side of the roller bed each in parallel to the direction of conveyance of the crop. Hereby, preferably, the driver means are positioned via the driver discs and the deflecting pulley or, respectively, the drive pinion and the deflection pinion. This saves space, and a compact cleaning device can be provided since the tappets are guided above the roller bed or, respectively, below the roller bed in suitable places. Moreover, the tappets can fulfill a certain function both above as well as below the roller bed.

Thus, due to the positioning of the driver means is can be achieved easily that the tappets ensure conveyance of the crop in the direction of conveyance above the roller bed and are being transported back below the roller bed in a turned-around manner. This happens continuously, based on the endless shape of the driver means. Thereby, additionally, the tappets can fulfill a cleaning function even below the roller bed since impurities potentially present on the bottom side of the roller bed can be carried along during the back transport.

In order to avoid accumulation of elongated or smaller crops, which, normally, cannot be conveyed along securely when the conveyance is effected by rotation of the rollers, the shape of the tappets, in particular, at a lower edge, can be adapted to the shape of the roller bed. This can avoid a build-up of crop and, therewith, a reduced flow of material. Additionally, the tappets may also, at least in part, be in contact with the roller bed or grind upon the same so as to better allow adherent impurities to be detached or scraped off respectively.

Preferably, it is provided to have the rotational axes of the drivable rollers of the roller bed be aligned in parallel or perpendicular or at an arbitrary angle between 0° and 90° in relation to the direction of conveyance. This helps achieve an efficient discharging of impurities through the gaps. Advantageously, the transport can still primarily be effected by the tappets according to the invention so that the operation and the design of the roller bed can be primarily adapted to the cleaning process.

Further, by way of support, is may be provided for at least a part of the rollers of the roller bed, preferably every other roller, to comprise a structured surface. Where the structure is designed as a coiled or helical structure on the surface of the rollers the forwarding of the crop in the direction of conveyance may be supported and, at the same time, the impurities can be pressed or pulled respectively into the gaps. It is also possible to have the surface of each roller structured with adjacent rollers, which are also rotated in opposite directions, having opposing threads in order to optimize the cleaning process.

Preferably, it is further provided that the tappets are made from a polymer and/or rods reinforcing the tappets extend between the driver means. This provides for a stabile as well as cost-effective measure for secure transport of the corps.

Further, according to the invention, a harvesting machine comprising a cleaning device according to the invention, whereby the harvesting process can be made efficient and secure by virtue of the cleaning process and the transport via the cleaning device. Preferably, the two driver means of the cleaning device, for example, endless bands or chains, can be combined in the harvesting machine with the driver means of a conveyor belt, for example, an inclined conveyor or a feeder belt, adjacent the cleaning device.

The invention is subsequently illustrated further by means of drawings. These show in:

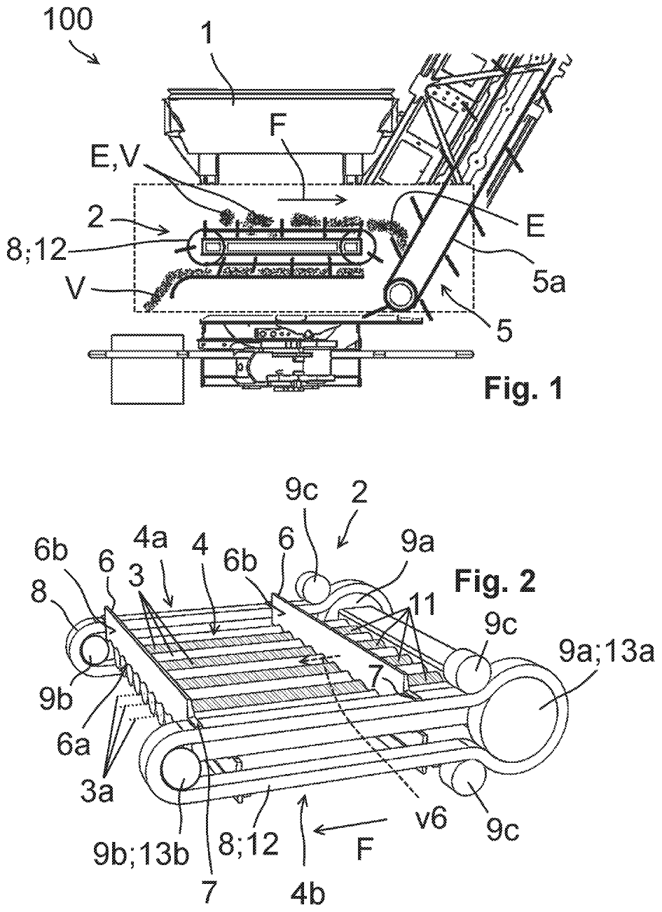

FIG. 1 a schematic design of a harvesting machine;

FIG. 2 a perspective representation of the cleaning device according to the invention in the harvesting machine according to FIG. 1;

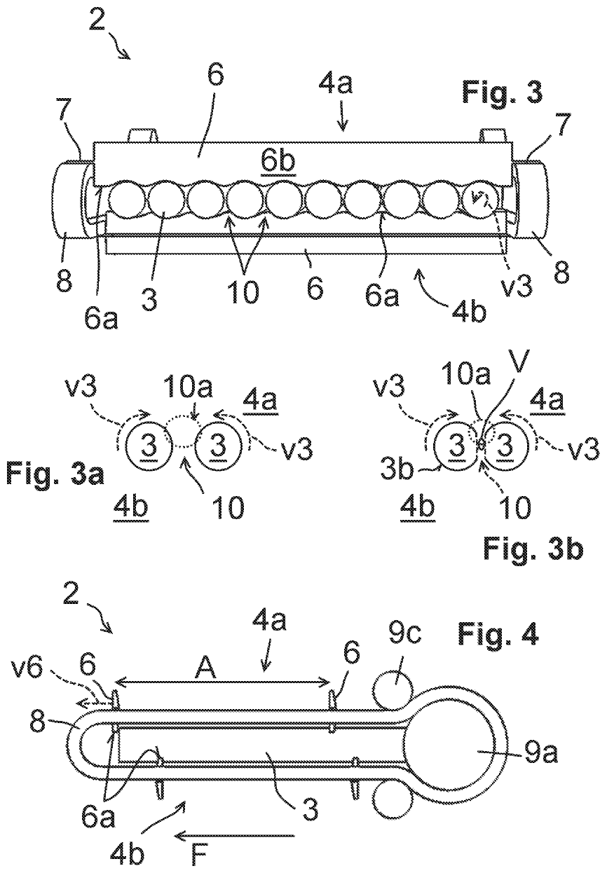

FIG. 3 a front view of the cleaning device according to FIG. 2;

FIG. 3a, 3b detailed views from FIG. 3; and

FIG. 4 a lateral view of the cleaning device according to FIG. 2.

FIG. 1 shows a schematic part of a harvesting machine 100 in which the crop E, for example, potatoes or sugar cane, is fed within a defined path of conveyance via a funnel 1 to a cleaning device 2 according to the invention which is located inside the harvesting machine 100. Alternatively, instead of the funnel 1, a feeder belt (not shown) may be provided for feeding in the crops E. The cleaning device 2 serves to sort out or filter out respectively and discharge impurities V carried along on or together with the crop E by the harvesting machine 100. Hereby, the yet uncleaned crop E and/or other unusable plant residue are fed via the funnel 1 onto a roller bed 4 of the cleaning device 2, shown in detail in FIG. 2, and are forwarded on the roller bed 4 in a direction of conveyance F towards a conveyor belt 5 or inclined conveyor respectively. Via the conveyor belt 5 the cleaned crop E is forwarded in the harvesting machine 100 in an upwards direction towards the nest following component of the chain of conveyance.

According to the invention, the cleaning device 2 serves, on the one hand, to clean the crops E fed in via the funnel 1 or the feeder belt and, on the other, to forward the fed-in crops E along the direction of conveyance F towards the conveyor belt 5, as described before. In order to achieve this, it is provided, according to FIG. 2, for the cleaning device 2 to be provided with several band-shaped tappets 6, each of the tappets 6 being affixed on both sides via bridges 7 to two endless belts 8 as driver means. The two belts 8 each run across a drive pulley 9a and a deflection pulley 9b so that, in operation when the drive pulley 9a is powered, the tappets 6 are also taken along. This causes the tappets 6 to move on an upper side 4a of the roller bed 4 at a tapper velocity v6 in the direction of conveyance F and on a bottom side 4b of the roller bed 4 deflected in a direction opposite the direction of conveyance F. Further, pressure rollers 9c may be provided in the area of the drive pulleys 9a ensuring a parallel path of the belts between the drive pulley 9a and the deflection pulley 9b.

Hereby, the endless belts 8 may be designed as cam belts or flat belts circulating on toothed or flat discs 9a, 9b, 9c. Thus, the belts 8 are primarily driven by a frictional connection or a positive locking connection. Alternatively, it may be provided to utilize endless chains 12 as endless driver means which circulate, in a corresponding manner, on drive pinions 13a and deflector pulleys 13b with the tappets 6 being arrange between them. The cleaning device 2 shall be described below primarily by means of endless belts 8 as exemplary driver means.

According to an embodiment not shown, the endless driver means 8, 12 of the cleaning device 2 may also be combines with endless driver means 5a in the conveyor belt 5 according to FIG. 1. In that case, further deflector pulleys or rollers (not shown) may be provided between the two elements 2, 5 on which the driver means 8, 12 run or are in contact with and which ensure a suitable positioning of the endless driver means 8. The tappets 6 on the conveyor belt 5 can ensure that the crops E already cleaned are forwarded at about the same speed of conveyance as on the cleaning device 2.

In this embodiment example, a lower edge 6a of the tappets 6 is designed to be wave-shaped so as to adapt the lower edge 6a facing the roller bed 4—just as shown in FIG. 3—to the path of the surface of the roller bed 4. Thus, the lower edge 6a of the tappet 6 follows approximately the contours of the roller bed 4. In this embodiment example, this applies both to the tappets 6 on the upper side 4a of the roller bed 4 and the deflected tappets 6 on the bottom side 4b of the roller bed 4. Hereby, the tappets 6 may also be in contact with the rollers 3 or, respectively, rub against these in operation. To that end, the position of the bridges 7 or the tappets 6 respectively on the belt 8 must by adjusted accordingly. Lateral faces 6b of the tappets 6 extend, starting from the lower edge 6a, upwards approximately perpendicular to the roller bed 4 or, respectively, to the direction of conveyance F, whereby the crop E can be carried along via the lateral faces 6b or, respectively, forced in the direction of conveyance F. The lateral faces 6b may also be slightly angled in relation to the direction of conveyance F.

The roller bed 4 itself comprises several rollers 3 that can be driven at an angular velocity or, respectively, roller velocity v3 about a rotational axis 3a, upon which rollers the fed-in crop E rests and the rotational axes 3a of which are aligned in parallel to each other and in parallel to the direction of conveyance F in this embodiment example. According to FIG. 3, a gap 10 is formed always between the rollers 3, whereby, in the harvesting machine 100, impurities V forwarded together with the crop E, for example, soil, stones or other unusable plant residue or leaves, can be discharged through these gaps 10. Hereby, the gaps 10 are to be dimensioned in such a way that the crop E itself normally cannot pass through the gaps 10.

According to an embodiment shown in FIG. 3b, the gaps 10 may be formed even subsequently. According to this, the rollers 3 are normally in contact with each other. The rollers 3 each have an elastic surface 3b which can be deformed by the impurities V when these end up in a funnel-shaped area 10a between the rollers 3 and are pressed between these by virtue of the rotational movement of the rollers 3. This subsequently forms a gap 10 between the rollers 3 through which the impurities V can be discharged. Thereafter, the gap 10 closes again by virtue of the elasticity of the surface 3b.

In this construction the tappets 6 have the function of effecting the transport of the corps E lying on the roller bed 4 or on the rollers 3 respectively in the direction of conveyance F in that the lateral face 6b facing the direction of conveyance F presses the crop E in the direction of conveyance F when the belts 8 are powered. Since the lower edge 6a of the tappet 6 is adapted to the path of the surface of the roller bed 4 the tappets 6 can even transport crops E located, at least in part, in the funnel-shaped area 10a above the gaps 10 between the rollers 3 (see FIGS. 3a, 3b). This allows the removal of even elongated crops E, for example sugar cane, or smaller crops E present between the rollers 3 in the funnel-shaped area 10a and obstructing the conveyance of following crop E in the direction of conveyance F and, therewith, the overall flow of material of the crop E which this gets jammed or acts on following crop E in a blocking or accumulating manner. Moreover, the removal via the tappets 6 can help avoid impending squashing of the crops E in the gaps 10 or in the funnel-shaped areas 10a above them.

Hereby, a distance A (see FIG. 4) of the tappets 6 on the belt 8 can be adapted to the crop E to be cleaned and forwarded. A suitable distance A as well as a suitable selection of the tappet velocity v6 can ensure that the crop E introduced via the funnel 1 at a certain feed-in velocity can be discharged efficiently at a corresponding discharge velocity, without the crop E accumulating on the roller bed 4 thereby compromising the harvesting process.

Hereby, the tappets 6 are provided in supplement of further optional measures ensuring the transport and the cleaning of the crops E on the cleaning device 2. Thus, for example, the rollers 3 of the roller bed 4 may be provided with a surface structure 11 (indicated in FIG. 2 merely schematically), for example, in the shape of threaded or spirally coiled sides on the surface of the respective roller 3. This leads to the crop E laying on the surface of the roller bed 4 is carried along and, therewith, transported in the direction of conveyance F when the spirally coiled roller 3 is correspondingly rotated. Depending on the size of the crops E is may be sufficient to provided such a surface structure 11 at every other roller 3 in order to cause at least a flow of material of the crop E in the direction of conveyance F to thereby support the transport by means of the tappets 6.

In support of the transport the roller bed 4 may also be angled downwards in the direction of conveyance F. However, it is also possible to provide an upwards conveyance via a roller bed 4 rising in the direction of conveyance F, whereby the upwards conveyance is then facilitated by thee tappets 6.

At the same time, a surface structure 11 on every or every other roller 3 also ensures shaking of the crop E on the roller bed 4 so that coarse impurities V connected loosely to the crop E, for example, soil or stones, fall off and can be discharged via the gaps 10. Even the rotational motion of the rollers 3 as such may contribute to this since it makes the crop E lying on top also rotate and loosely connected dirt falls off easily.

For the purpose of cleaning or, respectively, discharging the impurities V through the gaps 10 it is provided, in addition, that adjacent rollers 3 rotate in opposite direction of rotation about their rotational axes 3a so the impurities V present above the gaps 10 or, respectively, in the funnel-shaped area 10a, for example, including unusable plant residue or leaves, are pulsed or sucked respectively into the or, respectively, through the gaps 10 so that they can be discharged downwards. In support of this, it may be provided that each roller 3 is structured, whereby, in that case, an opposing threading is chosen in order to push the impurities V into the gap 10.

Thus, in summary, the cleaning device 2 according to the invention may ensure both the cleaning of the crops E and the transport of the crops E via the tappets 6 along the direction of conveyance F. Hereby the tapper velocity v6 can be chosen independent from the roller velocity v3 since the roller bed 4 is primarily responsible for the cleaning of the crops E and the tappets 6 are primarily responsible for the transport of the crops E.

By virtue of the fact that the tappets 6 are transported back in a deflected manner at the bottom side 4b of the roller bed 4, the bottom side 4b of the roller bed 4 can be cleaned at the same time. Impurities V jammed in the gaps 10 or the funnel-shaped areas 10a below and, therefore, cannot be completely discharged and/or adhere or stick to the rollers 3, can be carried along and/or loosened by the tappets 6 below the roller bed 4. To that end, the deflected tappets 6 move at the bottom side 4b only just below the rollers 3 of the roller bed 4. Hereby, the lower edge 6a may also rub or “scratch” against the rollers 3 at the bottom side 4b of the roller bed 4b to allow this to happen.

As a material for the rollers 3, for example, metal can be chosen which is coated with a vulcanized Polymer coating. The tappets 6, too, may be made of or coated with a polymer. Depending on the particular application, the tappets 6 may also be reinforced by rods extending between the bridges 7.

The endless belts 8 are preferably made of a fabric-reinforced polymer band which is made endless in a suitable manner. Hereby, depending on the particular application, two or more such belts 8 may be used which are powered in a suitable manner by the respective drive pulley 9a and between which the tappets 6 are arranged, whereby the belts 8 are to be suitably synchronized.

1. Cleaning device (2) for cleaning crops (E) comprising a roller bed (4), which comprises several rollers (3) rotating about a rotational axis (3a), whereby gaps (10) are provided or can be provided between said rollers (3) in such a way that impurities (V) located on an upper side (4a) of said roller bed (4) together with the crop (E) can be discharged through said gaps (10) while, at the same time, keeping said crop (E) on said upper side (4a), whereby said rollers (3) of said roller bed (4) can be driven in such a way that said impurities (V) can be discharged through said gaps (10), tappets (6) movable in a direction of conveyance (F) are arranged at least above said upper side (4a) of said roller bed (4) in such a way that crop (E) located on said upper side (4a) of said roller bed (4) can be carried along by said tappets (6) in the direction of conveyance (F), whereby, to that end, said tappets (6) extend between at least two driver means (8; 12), whereby at least the tappets (6) arranged above said upper side (4a) of said roller bed (4) can be moved by said at least two driver means (8; 12) at a tapper velocity (v6) in the direction of conveyance (F).

2. Cleaning device (2) according to claim 1, at least two driver means (8; 12) are each designed as endless driver means and—are endless belts (8), each endless belt (8) running across at least one drive pulley (9a) and/or at least one deflection pulley (9b) and can be driven via the respective associated drive pulley (9a), or—are endless chains (12), each endless chain (12) running across at least one drive pinion (13a) and/or at least one deflection pinion (13b) and can be driven via the respective associated drive pinion (13a), so that the tappets (6) extending between said at least two endless driver means (8; 12) and being attached to said endless driver means (8; 12) can be moved at the tapper velocity (v6) in an endlessly circulating manner.

3. Cleaning device (2) according to claim 1 or 2, said driver means (8; 12) are arranged in relation to said roller bed (4) in such a way that the tappets (6) attached to said endless driver means (8; 12), when said driver means (8; 12) can be driven alternatingly above said upper side (4a) and partially below a bottom side (4b) of said roller bed (4) always parallel to the direction of conveyance (F) at the tapper velocity (v6) so that a tappet (6) can be moved via said driver means (8; 12) in the direction of conveyance (F) when this tappet (6) is located above said upper side (4a) of said roller bed (4), and a tappet (6) can be moved via said driver means (8; 12) in the direction opposite the direction of conveyance (F) when this tappet (6) is located below said bottom side (4b) of said roller bed (4).

4. Cleaning device (2) according to one of the above claims, a lower edge (6a) of said tappets (6), said lower edge (6a) facing towards the roller bed (4) continuously or at least on the upper side (4a) of the roller bed (4) and being adapted to a course of the surface of the roller bed (4), so that said tappets (6) protrude, at least in part and/or at times, into a funnel-shaped area (10a) immediately adjacent the gap (10).

5. Cleaning device (2) according to claim 4, said lower edge (6a) of said tappets (6) runs undulated or in a zigzagged configuration.

6. Cleaning device (2) according to claim 4 or 5, said lower edge (6a) of said tappets (6) is in contact, at least in a certain area, with said rollers (3) of said roller bed (4).

7. Cleaning device (2) according to one of the above claims, said tappets (6) are designed ribbon-shaped and a lateral face (6b) of said movable ribbon-shaped tappet (6) carrying along the crop (E) on the upper side (4a) of the roller bed (4) extends, at least in part, between said driver means (8; 12), said lateral face (6b) being aligned approximately perpendicular or slightly angled, preferable at an acute angle, in relation to the direction of conveyance (F).

8. Cleaning device (2) according to one of the above claims, the rotational axes (3a) of the drivable rollers (3) of the roller bed (4) are aligned in parallel or perpendicular or at an angle between 0° and 90° relative to the direction of conveyance (F) of the crop (E).

9. Cleaning device (2) according to one of the above claims, adjacent rollers (3) of the roller bed (4) can be rotated in opposite directions about their rotational axes (3a).

10. Cleaning device (2) according to one of the above claims, at least a part of said rollers (3) of the roller bed (4) comprises a structured surface (11).

11. Cleaning device (2) according to claim 10, said structured surface is designed as a helical or spiral structure (11) on the surface (3b) of the roller (3).

12. Cleaning device (2) according to one of the above claims, said tappets (6) are made from a polymer and/or rods reinforcing said tappets (6) extend between the driver means (8; 12).

13. Cleaning device (2) according to one of the above claims, the tapper velocity (v6) can be adjusted independent of a roller velocity (v3) at which the rollers (3) rotate about their rotational axis (3a).

14. Harvesting machine (100) comprising a cleaning device (2) according to one of the above claims.

15. Harvesting machine (100) according to claim 14, said at least two driver means (8; 12) of said cleaning device (2) are combined with driver means (5a) of a conveyor belt (5) adjacent the cleaning device (2).
